(19) United States
(12) Patent Application Publication
(10) Pub. No.: US 2010/0094623 A1
(43) Pub. Date: Apr. 15, 2010

(54) ENCODING DEVICE AND ENCODING METHOD

(75) Inventors: Toshiyuki Morii, Kanagawa (JP); Koji Yoshida, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/528,871

(22) PCT Filed: Feb. 29, 2008
(86) PCT No.: PCT/JP2008/000398

§ 371 Date: Aug. 27, 2009

(30) Foreign Application Priority Data
Mar. 2, 2007 (JP) 2007-053501

(51) Int. Cl. G10L 19/00

(52) U.S. Cl. 704/230; 704/E19.001

(57) ABSTRACT

Provided is an encoding device which performs a fixed sound source codebook search with a small calculation amount even in a low-bit rate sound encoding without lowering the encoding efficiency. In the encoding device, a threshold value calculation unit (211) evaluates a correlation value of candidate positions sorted in each channel over a plurality of channels so as to identify the candidate position of each channel and adds the correlation values of the candidate positions of the respective channels so as to obtain a threshold value. A candidate position sorting unit (212) sorts the pulse candidate positions according to correlation between a combined sound of pulses arranged at a pulse position of each channel and a quantization target. A search control unit (221) performs control so that search is performed at the sorted pulse candidate position. If the sum of the correlation values already searched in the channel to be searched is below the threshold value, a control signal is outputted to a search termination unit (223). The search terminal unit (223) terminates the search at the pulse position candidate by the control signal inputted from the search control unit (221).

### TECHNICAL FIELD

The present invention relates to a coding apparatus and coding method that encode speech signals and audio signals.

### BACKGROUND ART

In mobile communication, it is necessary to compress and encode digital information such as speech and images for efficient use of radio channel capacity and storage media for radio waves, and many coding and decoding schemes have been developed so far.

Among these, the performance of speech coding technology has been improved significantly by the fundamental scheme of “CELP (Code Excited Linear Prediction),” which skillfully adopts vector quantization by modeling the vocal tract system of speech. Further, the performance of sound coding technology such as audio coding has been improved significantly by transform coding techniques (such as MPEG-standard ACC and MP3).

Further, the performance of speech coding technology has been improved significantly by the invention such as an algebraic codebook (disclosed in Non-Patent Document 1) that represents a fixed excitation by a small number of pulses, thereby providing good performance even when the amount of calculations is relatively small.

As an algorithm for searching for excitations of an adaptive excitation codebook or fixed excitation codebook, open-loop search is used in the CELP scheme to reduce the amount of calculations.

A conventional search method for a fixed excitation codebook will be explained below using an algebraic codebook as an example. First, an excitation code is found by searching for the excitation to minimize the coding distortion of following equation 1.

(Equation 1)

E=|x−(pHa+qHs)|² [1]

E: coding distortion

x: coding target

p: gain of adaptive excitation

H: perceptual weighting synthesis filter

a: adaptive excitation

q: gain of fixed excitation

s: fixed excitation

An adaptive excitation is subjected to search in an open-loop, and, consequently, a code of an algebraic codebook is found by searching for the fixed excitation to minimize the coding distortion of following equation 2.

(Equation 2)

y=x−pHa

E=|y−qHs|² [2]

E: coding distortion

x: coding target (perceptually weighted speech signal)

p: optimal gain of adaptive excitation

H: perceptual weighting synthesis filter

a: adaptive excitation

q: gain of fixed codebook

s: fixed excitation

y: target vector in fixed excitation

Here, gains p and q are determined after an excitation code is searched for, and, consequently, it is assumed to perform a search using optimal gains. As a result, above equation 2 can be expressed by following equation 3.

$$y = x - \frac{x * Ha}{{\vert Ha \vert}^{2}} Ha \\ E = {\vert y - \frac{y * Hs}{{\vert Hs \vert}^{2}} Hs \vert}^{2} \qquad ( Equation 3 )$$

Further, minimizing this equation for coding distortion is equivalent to maximizing function C of following equation 4.

$$C = \frac{{( yH \cdot s )}^{2}}{sHHs} \qquad ( Equation 4 )$$

Therefore, to search for an excitation comprised of a small number of pulses such as an algebraic codebook excitation, it is possible to calculate the above function C with a small amount of calculations by calculating yH and HH in advance.

A pulse search algorithm of an algebraic codebook will be explained below. An algebraic codebook excitation is comprised of a small number of pulses having an amplitude of 1 and polarity (+/−). An example case will be explained below where the number of subframes is thirty-two and the number of pulses is four (i.e. the number of channels is four).

Pulse positions in the algebraic codebook are set not to overlap with each other, as shown in following equation 5.

(Equation 5)

position of pulse 0=[0, 4, 8, 12, 16, 20, 24, 28]

position of pulse 1=[1, 5, 9, 13, 17, 21, 25, 29]

position of pulse 2=[2, 6, 10, 14, 18, 22, 26, 30]

position of pulse 3=[3, 7, 11, 15, 19, 23, 27, 31] [5]

Therefore, it is understood that this algebraic codebook including polarities is encoded by a code of (3+1)×4=16 bits.

The steps of a search will be shown below. First, as preprocessing, vector yH and matrix HH are calculated. yH is calculated by reversing the order of vector y, convoluting matrix H over the reversed y and further reversing the result of the convolution. HH is calculated by multiplying the matrixes.

The polarities (+/−) of pulses are determined in advance from the polarities of the elements of vector yH. To be more specific, the polarities of pulses that occur in respective positions are coordinated with the polarities of the values of yH in those positions, and the polarities of the yH values are stored in a separate sequence. After the polarities in these positions are stored in the separate sequence, the yH values are all made absolute values, that is, the yH values are converted into positive values. Further, the polarities of the HH values are multiplied by polarities and converted in association with the stored polarities.

Function C is calculated by adding the yH values and HH values using a quadruple loop (because the number of pulses (channels) is four in the embodiment described later), and the position to maximize this value is subjected to search. A fixed excitation code is produced by combining the code and polarity in each pulse position.

A search using the above-noted quadruple loop will be explained below using FIG. 1 and FIG. 2. FIG. 1 and FIG. 2 are flowcharts showing a conventional algebraic codebook search algorithm.

First, initialization is performed in step (hereinafter “ST”) 11, and the first pulses i0's are outputted one by one from an algebraic codebook to find the values of yH and HH and use these values as the correlation value sy0 and excitation power sh0 (ST 13). This calculation is repeated until i0 reaches eight (which is the number of pulse position candidates) (ST 12 to ST 14).

As for the calculation of one of i0's, the second pulses i1's are outputted one by one from the algebraic codebook to find the values of yH and HH, and these values are added to the correlation value sy0 and power sh0, respectively, to calculate correlation value sy1 and power sh1 (ST 16). This calculation is repeated until i1 reaches eight (which is the number of pulse position candidates) (ST 15 to ST 17).

As for the calculation of one of i1's, the third pulses i2's are outputted one by one from the algebraic codebook to find the values of yH and HH, and these values are added to the correlation value sy1 and power sh1, respectively, to calculate correlation value sy2 and power sh2 (ST 19). This calculation is repeated until i2 reaches eight (which is the number of pulse position candidates) (ST 18 to ST 20).

As for the calculation of one of i2's, the fourth pulses i3's are outputted one by one from the algebraic codebook to find the values of yH and HH, and these values are added to the correlation value sy2 and power sh2, respectively, to calculate correlation value sy3 and power sh3 (ST 22). This calculation is repeated until i3 reaches eight (which is the number of pulse position candidates) (ST 21 to ST 23).

The correlation value sy3 and power sh3 acquired as above are compared to the maximum value heretofore (ST 24) and the position with the maximum value is subjected to search (ST 25). A search in the algebraic codebook is performed by this algorithm.

Non-Patent Document 1: Algebraic Codebook: Salami, Laflamme, Adoul, “8 kbit/s ACELP Coding of Speech with 10 ms Speech-Frame: a Candidate for CCITT Standardization”, IEEE Proc. ICASSP94, pp.II-97n

### DISCLOSURE OF INVENTION

### Problems to be Solved by the Invention

As described above, although a search in a fixed excitation codebook can be performed with a relatively small amount of calculations by using an algebraic codebook, a search in a loop of the depth corresponding to the number of pulses is required (in the above example, the number of pulses is four, and therefore a quadruple loop is required), and, consequently, the amount of calculations increases exponentially (the fourth power of eight in the above example). Especially in speech coding at a low bit rate, there is a problem that more pulses are required and therefore a larger amount of calculations is required.

It is therefore an object of the present invention to provide a coding apparatus and coding method that can perform a search in a fixed excitation codebook without degrading coding performance with a small amount of calculations in speech coding at a low bit rate.

### Means for Solving the Problem

The coding apparatus of the present invention, using a codebook which represents a fixed excitation by a small number of pulses and which sets candidate positions of a pulse on a per channel basis, searches for an optimal pulse position from the candidate positions of each channel in a loop of a depth corresponding to a number of channels, and employs a configuration having: a candidate position sorting section that rearranges the candidate positions of each channel subject to search in a search loop, based on correlation values between synthesis sounds of pulses allocated in the candidate positions of each channel, and a quantization target; a threshold calculating section that evaluates magnitudes of the correlation values of the rearranged candidate positions of each channel, over a plurality of channels, specifies a reference candidate position of each channel based on evaluation results, and calculates a threshold using a correlation value of the reference candidate position of each channel; and a search controlling section that searches for a pulse position in order of the rearranged candidate positions and terminates a search based on a comparison result between a representative value set using correlation values of candidate positions subjected to search in a channel of a search target, and the threshold.

The coding method of the present invention, using a codebook which represents a fixed excitation by a small number of pulses and which sets candidate positions of a pulse on a per channel basis, searches for an optimal pulse position from the candidate positions of each channel in a loop of a depth corresponding to a number of channels, and includes: a candidate position sorting step of rearranging the candidate positions of each channel subject to search in a search loop, based on correlation values between synthesis sounds of pulses allocated in the candidate positions of each channel, and a quantization target; a threshold calculating step of evaluating magnitudes of the correlation values of the rearranged candidate positions of each channel, over a plurality of channels, specifies a reference candidate position of each channel based on evaluation results, and calculates a threshold using a correlation value of the reference candidate position of each channel; and a search controlling step of searching for a pulse position in order of the rearranged candidate positions and terminates a search based on a comparison result between a representative value set using correlation values of candidate positions subjected to search in a channel of a search target, and the threshold.

### ADVANTAGEOUS EFFECTS OF INVENTION

According to the present invention, it is possible to save the amount of calculations for search processing when the correlation values are low between the synthesis sounds of pulses allocated in candidate positions of each channel and the quantization target, and reduce the average amount of calculations without degrading coding performance.

### BRIEF DESCRIPTION OF DRAWINGS

FIG. 1 is a flowchart showing a conventional algebraic codebook search algorithm;

FIG. 2 is a flowchart showing a conventional algebraic codebook search algorithm;

FIG. 3 is a block diagram showing the configuration of a speech coding apparatus according to an embodiment of the present invention;

FIG. 4 is a block diagram showing the configuration of an excitation search circuit of a speech coding apparatus according to an embodiment of the present invention;

FIG. 5 is a flowchart showing the algorithm of sorting according to an embodiment of the present invention;

FIG. 6 is a flowchart showing an algebraic codebook search algorithm according to an embodiment of the present invention;

FIG. 7 is a flowchart showing an algebraic codebook search algorithm according to an embodiment of the present invention;

FIG. 8 is a flowchart showing the algorithm to calculate a threshold according to an embodiment of the present invention;

FIG. 9 is a flowchart showing the algorithm to calculate a threshold according to an embodiment of the present invention;

FIG. 10 illustrates an example of sorted correlation values according to an embodiment of the present invention;

FIG. 11 illustrates an example of sorted correlation values according to an embodiment of the present invention;

FIG. 12 is a flowchart showing the algorithm to calculate a threshold according to an embodiment of the present invention; and

FIG. 13 illustrates another example of sorted correlation values according to an embodiment of the present invention.

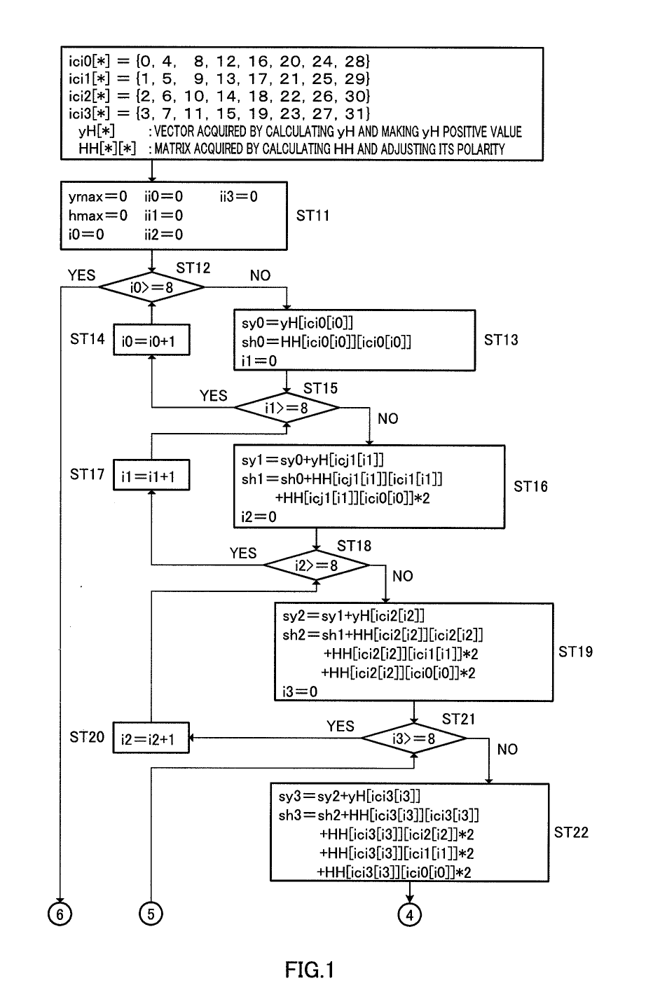

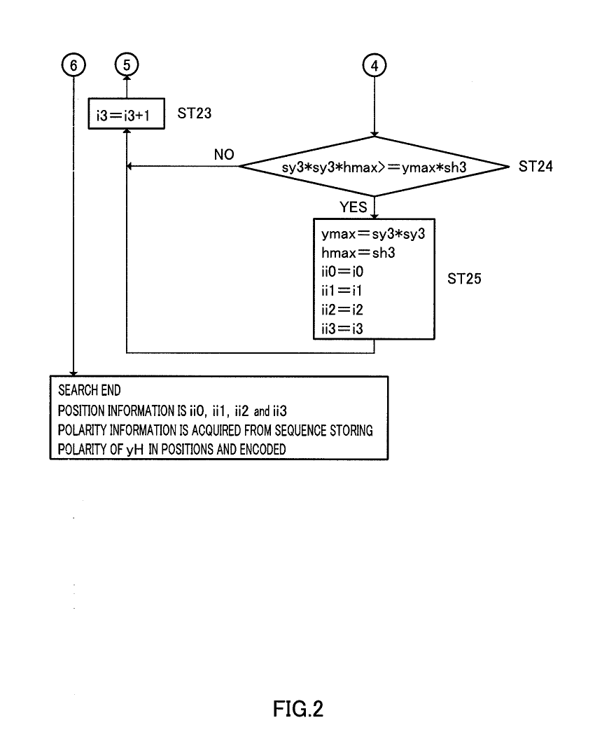

### BEST MODE FOR CARRYING OUT THE INVENTION

The present embodiment sets a threshold to decide a search stop based on correlation values between the synthesis sounds of pulses allocated in candidate positions of each channel and the quantization target, and does not perform a search in a loop of a greater depth if a sum of correlation values is lower than the threshold in the middle of a loop search. Further, the present embodiment evaluates the magnitudes of the correlation values of candidate positions sorted per channel, over a plurality of channels, specifies the reference candidate position of each channel and calculates a threshold by adding the correlation values of the specified reference candidate positions in the channels.

An embodiment of the present invention will be explained below using the accompanying drawings.

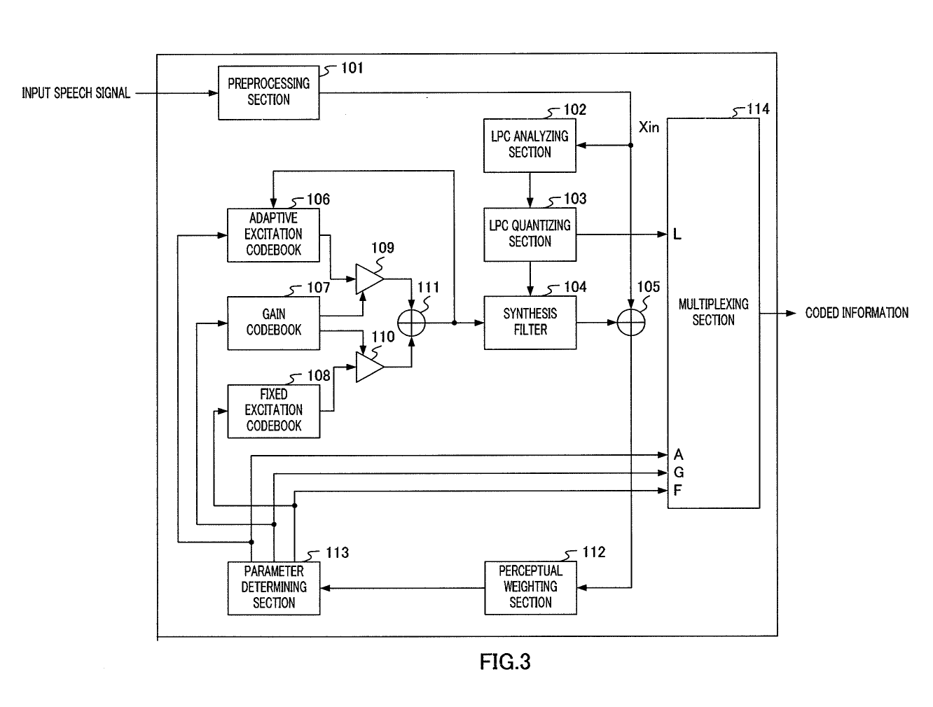

FIG. 3 is a block diagram showing the configuration of a speech coding apparatus according to the present embodiment.

Pre-processing section 101 processes an input signal by performing high pass filter processing that removes the DC components, and waveform shaping processing and preemphasis processing that lead to improved performance in subsequent coding processing, and outputs the signal (Xin) after these processing, to LPC analyzing section 102 and adding section 105.

LPC analyzing section 102 performs a linear prediction analysis using Xin, and outputs the analysis result (i.e. linear prediction coefficient) to LPC quantizing section 103. LPC quantizing section 103 performs quantization processing of the linear prediction coefficient (“LPC”) outputted from LPC analyzing section 102, outputs the quantized LPC to synthesis filter 104 and outputs the code (L) representing the quantized LPC to multiplexing section 114.

Synthesis filter 104 generates a synthesis signal by performing filter synthesis with respect to an excitation outputted from adding section 111, which will be described later, using filter coefficients based on the quantized LPC, and outputs the synthesis signal to adding section 105.

Adding section 105 calculates the error signal by inverting the polarity of the synthesis signal and adding the resulting signal to Xin, and outputs the error signal to perceptual weighting section 112.

Adaptive excitation codebook 106 that stores the excitations outputted in the past by adding section 111 in a buffer, extracts one frame of samples from the past excitations specified by a signal to be outputted from parameter determining section 113 as an adaptive excitation vector, and outputs the adaptive excitation vector to multiplying section 109.

Gain codebook 107 outputs the adaptive excitation gain and fixed excitation gain specified by the signals outputted from parameter determining section 113, to multiplying section 109 and multiplying section 110, respectively.

Fixed excitation codebook 108 stores a plurality of pulse excitation vectors having a predetermined shape in a buffer, and outputs the pulse excitation vector having a shape specified by the signal outputted from parameter determining section 113, to multiplying section 110 as a fixed excitation vector. Further, fixed excitation codebook 108 may output a result of multiplying the pulse excitation vector by a spreading vector, to multiplying section 110 as a fixed excitation vector.

Multiplying section 109 multiplies the adaptive excitation vector outputted from adaptive excitation codebook 106 by the gain outputted from gain codebook 107, and outputs the result to adding section 111. Multiplying section 110 multiplies the fixed excitation vector outputted from fixed excitation codebook 108 by the gain outputted from gain codebook 107, and outputs the result to adding section 111.

Adding section 111 receives as input the adaptive excitation vector and fixed excitation vector subjected to gain multiplication from multiplying section 109 and multiplying section 110, respectively, adds these vectors and outputs an excitation indicating the addition result to synthesis filter 104 and adaptive excitation codebook 106. Further, the excitation inputted in adaptive excitation codebook 106 is stored in a buffer.

Perceptual weighting section 112 performs perceptual weighting of the error signal outputted from adding section 105 and outputs the result to parameter determining section 113 as coding distortion.

Parameter determining section 113 searches for the adaptive excitation vector, fixed excitation vector and quantization gain to minimize the coding distortion outputted from perceptual weighting section 112, and outputs the code (A) representing the searched adaptive excitation vector, the code (F) representing the searched fixed excitation vector and the code (G) representing the searched excitation gain code, to multiplexing section 114.

Multiplexing section 114 receives as input the code (L) representing the quantized LPC from LPC quantizing section 103, receives as input the code (A) representing the adaptive excitation vector, the code (F) representing the fixed excitation vector and the code (G) representing the quantization gain from parameter determining section 113, and multiplexes and outputs these information as coded information.

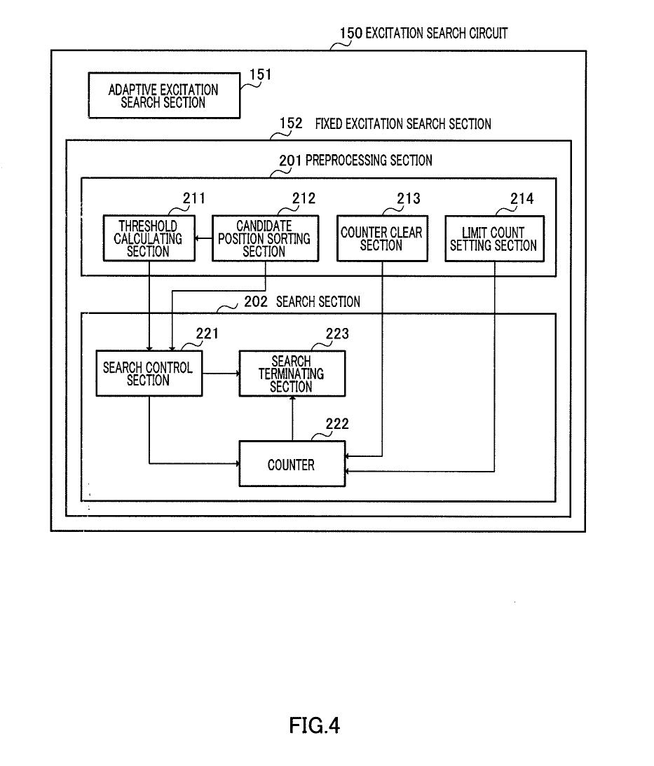

FIG. 4 is a block diagram showing the configuration of an excitation search circuit of the speech coding apparatus according to the present embodiment. This excitation search circuit is provided in parameter determining section 113 of the speech coding apparatus shown in FIG. 3.

Excitation search circuit 150 shown in FIG. 4 is provided with adaptive excitation search section 151 that searches for adaptive excitations of adaptive excitation codebook 106 and fixed excitation search section 152 that searches for fixed excitations of fixed excitation codebook 108.

Fixed excitation search section 152 is provided with preprocessing section 201 and search section 202. Preprocessing section 201 is provided with threshold calculating section 211, candidate position sorting section 212, counter clearing section 213 and limit count setting section 214. Also, search section 202 is provided with search controlling section 221, counter 222 and search terminating section 223.

In this fixed excitation search section 152, threshold calculating section 211 of preprocessing section 201 calculates a threshold to terminate a search, that is, a correlation value to decide whether or not to perform a search in a loop of a greater depth. The method of calculating a threshold according to the present embodiment will be described later.

Candidate position sorting section 212 of preprocessing section 201 rearranges the order to output pulse candidate positions from individual channels in order of the magnitude of elements, based on the magnitude of the elements of vector yH in which the values of all the elements are converted to positive values in each channel. The resulting order is outputted to threshold calculating section 211 and search controlling section 221 of search section 202.

Counter clear section 213 of preprocessing section 201 resets counter 222 of counter 202.

Limit count setting section 214 of preprocessing section 201 defines the limit count R to stop a search with reference to the value in counter 222. This limit count R is set and then outputted to counter 222, and, if the count exceeds the limit count R set in limit count setting section 214, counter 222 sends a control signal to search terminating section 223.

Searching controlling section 221 of search section 202 performs a control such that a search is performed in the pulse candidate positions sorted in candidate position sorting section 212. Further, search controlling section 221 performs a threshold determination for the sum of correlation values subjected to search in a channel of the search target. Further, search controlling section 221 outputs a control signal to counter 222 if the sum is equal to or higher than the threshold, while outputting a control signal to search terminating section 223 if the sum is smaller than the threshold.

Counter 222 of search section 202 counts the number of times the sum is decided to be equal to or higher than the threshold, compares this count and the limit count R, and, if this count exceeds R, outputs a control signal to terminate the search altogether, to search terminating section 223.

According to the control signal received as input from search controlling section 221 or counter 222, search terminating section 223 of search section 202 terminates a search in the pulse position candidate and finishes the search altogether.

A search method for the fixed excitation codebook in fixed excitation search section 152 having the above-described configuration, will be explained. First, the pulse search algorithm of an algebraic codebook according to the present invention will be explained.

An excitation of the algebraic codebook is formed with a small number of pulses having an amplitude of 1 and polarity (+/−). An example case will be explained below where the subframe length is thirty-two and the number of pulses is four. Pulse positions in the algebraic codebook are allocated not to overlap with each other, as shown in equation 5. Therefore, it is understood that this algebraic codebook including polarities is encoded by a code of (3+1)×4=16 bits.

The steps of a search will be shown below. First, as preprocessing, vector yH and matrix HH are calculated. yH is calculated by reversing the order of vector y, convoluting matrix H over the reversed y and further reversing the result of the convolution. HH is calculated by multiplying the matrixes.

The polarities (+/−) of pulses are determined in advance from the polarities of the elements of vector yH. To be more specific, the polarities of pulses that occur in respective positions are coordinated with the polarities of the values of yH in those positions, and the polarities of the yH values are stored in a separate sequence (after that, the code of the polarity is determined with reference to the polarity of this sequence). After the polarities in these positions are stored in the separate sequence, the yH values are all made absolute values, that is, the yH values are converted to positive values. Further, the polarities of the HH values are multiplied by polarities and converted in association with the stored polarities.

Next, with reference to the yH values of the pulse candidate positions, candidate position sorting section 212 sorts these values in order from the highest value and stores the candidate positions in a separate sequence. Since only eight values are rearranged, this rearrangement can be realized with a small amount of calculations.

A high value in a certain position in vector yH indicates a high correlation between the target and the synthesis sound of the pulse in the position, that is, there is a high possibility that this pulse is selected as one in the optimal combination of pulses. Thus, by rearranging the candidate positions in descending order of vector yH values, a search is performed in order from the pulse candidate position having the highest correlation, so that, even if the search is terminated in the middle, it is possible to reduce the probability of missing a search for the optimal combination. As a result, it is possible to perform a search for the optimal combination of pulse positions with a high probability and small amount of calculations.

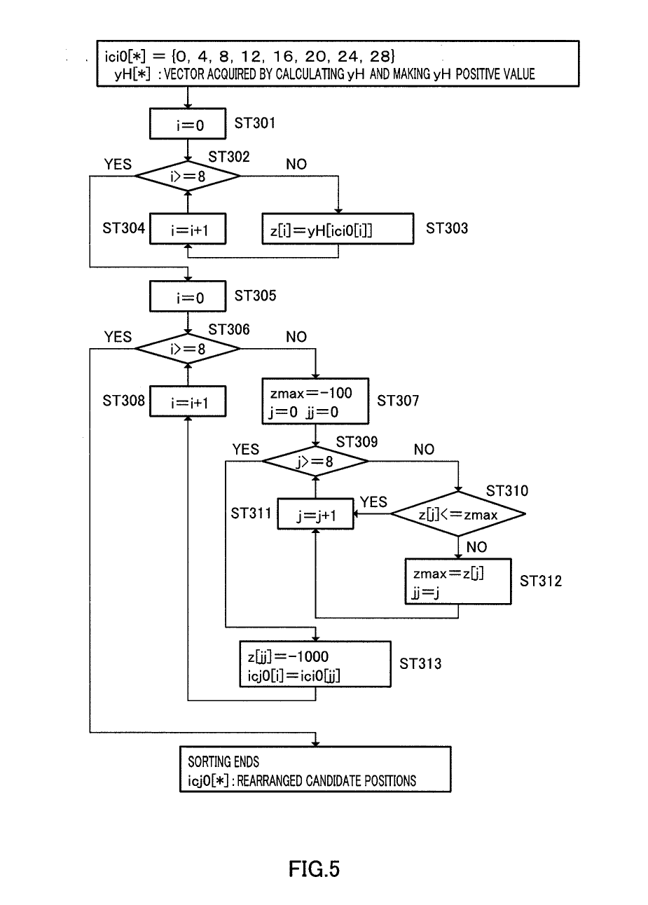

This sorting algorithm will be explained using FIG. 5. Here, channel “0” will be described as an example.

First, “i” is initialized (ST 301), the yH values of eight pulse candidate positions (0, 4, 8, 12, 16, 20, 24, 28) (ST 303), and these values are written down in Z[i] (ST 302 to ST304).

Next, “i” is initialized again (ST 305), and Zmax is set to a small enough value not to be selected (ST 307). Zmax and Z[j] are compared while increasing the value of “j” (ST 310), and, if Z[j] is higher than Zmax, Zmax is rewritten by Z[j] (ST 312). Since the initial value of Zmax is set to be small, this rewriting is surely implemented at the first comparison. Then, “j” of this rewritten Z[j] is stored as “jj.” This process is repeated until j reaches eight (ST 309 to ST 312).

By this means, the maximum Zmax and the index jj at that time are determined. Then, Z[jj] is set to be a small value not to be selected (ST 313). By this means, “jj” determined once is not selected next time, and the processing similar to the above-described processing is performed with respect to the rest of seven pulse candidate positions, so that the gradually increasing values and the indices at those times are determined (ST 306 and ST 308). Similarly, a rearrangement is performed for channels 1 to 3.

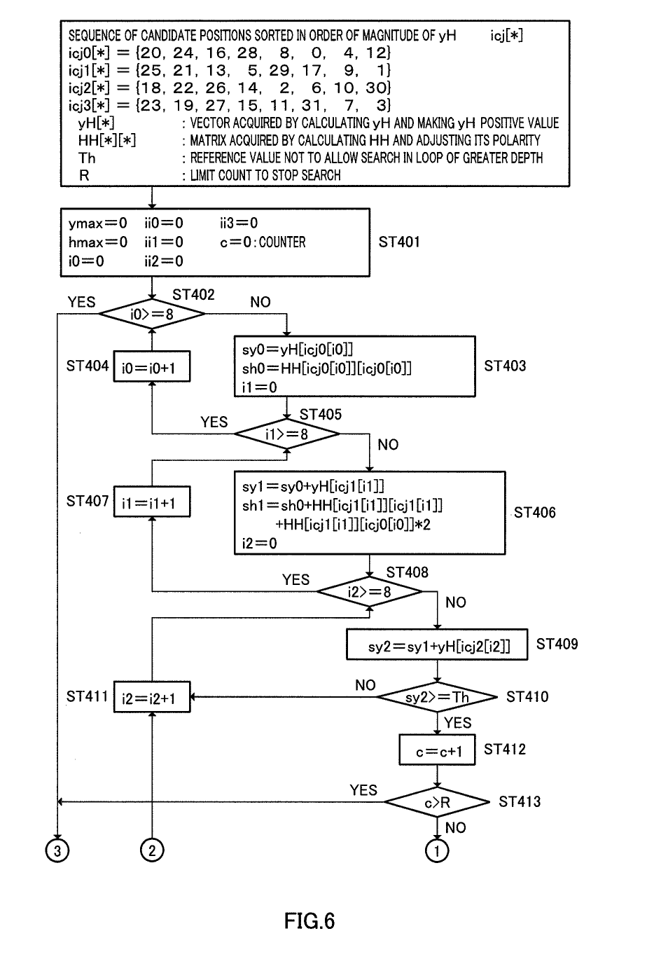

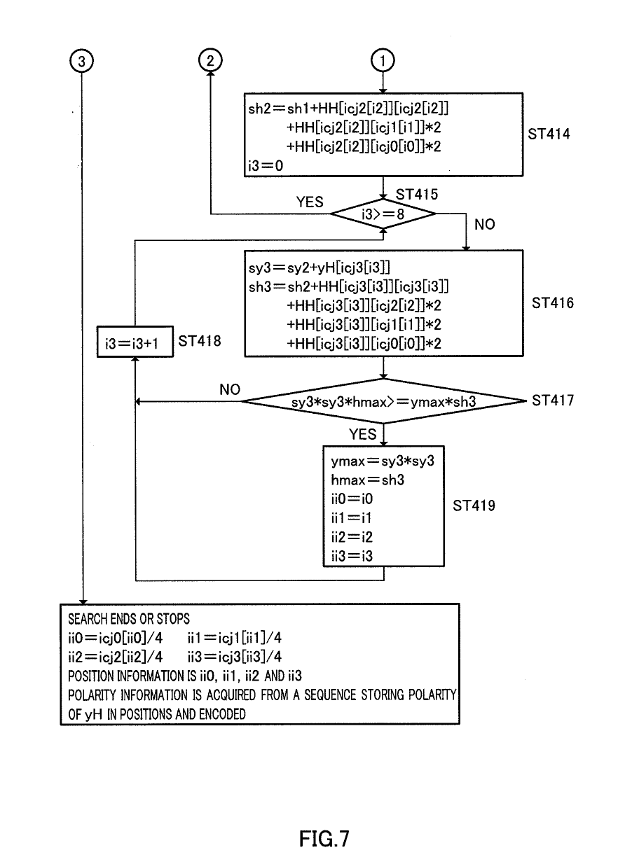

Next, a case will be explained using FIG. 6 and FIG. 7, where a search is performed in the above-described, searched pulse candidate positions. FIG. 6 and FIG. 7 are flowcharts showing the algebraic codebook search algorithm according to the present embodiment.

First, initialization is performed in ST 401, and the first pulses are outputted from fixed excitation codebook 108 to find the values of yH and HH and use these values as the correlation value sy0 and excitation power sh0 (ST 403). This calculation is repeated until i0 reaches eight (which is the number of pulse position candidates) (ST 402 to ST 404).

As for the calculation of one of i0's, the second pulses are outputted from fixed excitation codebook 108 to find the values of yH and HH, and these values are added to correlation value sy0 and power sh0, respectively, to calculate the correlation value sy1 and power sh1 (ST 406). This calculation is repeated until it reaches eight (which is the number of pulse position candidates) (ST 405 to ST 407).

As for the calculation of one of i1's, the third pulses are outputted from fixed excitation codebook 108 to find the values of yH and HH, and these values are added to the correlation value sy1 and power sh1, respectively, to calculate the correlation value sy2 and power sh2 (ST 409). Here, whether the search is terminated is decided (ST 410). Thus, a case will be explained with the present embodiment, where a decision is performed when the third loop is finished. Here, if a decision is performed when a different loop is finished, it is possible to produce the same effect.

In ST410, if the correlation value sy2 is equal to or higher than the threshold Th, the count in counter 222 is incremented by one (ST 412). If the correlation value sy2 is equal to or higher than the threshold Th, it means that the correlation value is high, and the flow proceeds to search in a loop of a grater depth. That is, this calculation is performed until i2 reaches eight (i.e. the number of pulse position candidates) (ST 408 to ST 411 and ST 414).

Next, as for the calculation of one of i2's, the fourth pulses are outputted from fixed excitation codebook 108 to find the values of yH and HH, and these values are added to the correlation value sy2 and power sh2, respectively, to calculate the correlation value sy3 and power sh3 (ST 416). This calculation is repeated until i3 reaches eight (which is the number of pulse position candidates) (ST 415 to ST 418).

The correlation value sy3 and power sh3 acquired as above are compared to the maximum value heretofore (ST 417), and the position of the maximum value is subjected to search (ST 419). A search in the algebraic codebook is performed by this algorithm.

That is, in the above processing, a search is performed up to the loop of a predetermined depth, and a search is performed in a loop of a greater depth if the sum of the correlation values added heretofore exceeds the above-noted threshold, while a search is not performed in a loop of a greater depth if the sum is lower than the threshold.

Also, counter 222 compares the count and limit count R (ST 413), and, if the count C exceeds the limit count R, transmits a control signal to search terminating section 223, and search terminating section 223 terminates the search (search stop). On the other hand, if the count C is smaller than the limit count R, the flow proceeds to a search in a loop of a greater depth as described above.

That is, in this processing, using a counter that counts the number of times a search is performed in a predetermined deep loop, counter 222 counts the number of times a search is decided to perform in a loop of a greater depth. If the value of the counter exceeds a predetermined limit count, the search is terminated.

Using a quadruple loop (since the number of pulses is four), correlation values and power are calculated from the values of yH and HH, and the pulse positions of the highest correlation are subjected to search. Then, a code of the fixed excitation is produced by combining the code and polarity in each pulse (stored in a separate sequence as described above).

Next, the method of calculating a threshold according to the present embodiment will be explained in detail. According to the present embodiment, the magnitudes of the correlation values of candidate positions sorted in each channel are evaluated over a plurality of channels, the candidate position used for the threshold calculation in each channel (hereinafter “reference candidate position”) is specified, and the correlation values of the reference candidate positions in the channels are added to calculate a threshold.

According to the present embodiment, candidate positions are subjected to search over channels in descending order of the correlation values, and the reference candidate positions are specified when the sum of numbers of candidate positions subjected to search reaches the predetermined number of candidates. Further, in this case, it is necessary to perform sorting not to exceed the number of entries in each channel.

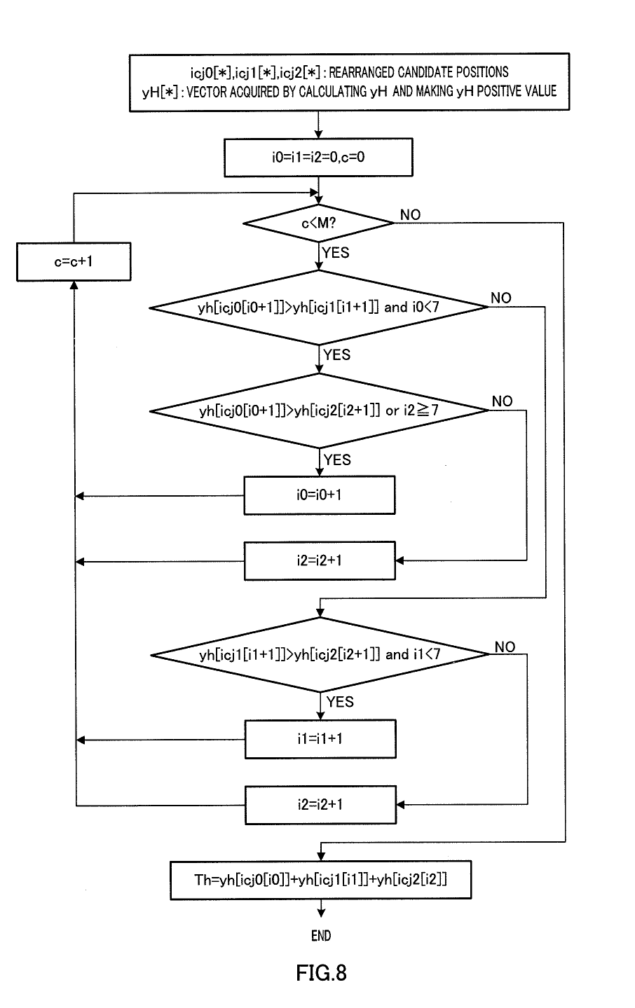

FIG. 8 is a flowchart showing the algorithm to calculate a threshold according to the present embodiment, and illustrates whether or not to perform a search for the fourth pulse based on the search results up to the third pulse. Here, in the flowchart of FIG. 8, i0, i1 and i2 represent the index in each channel to calculate a threshold, c represents the counter, Th represents the threshold, and M represents the number of candidates to determine the magnitude of a threshold. M is a constant and is set to around 12 to 16.

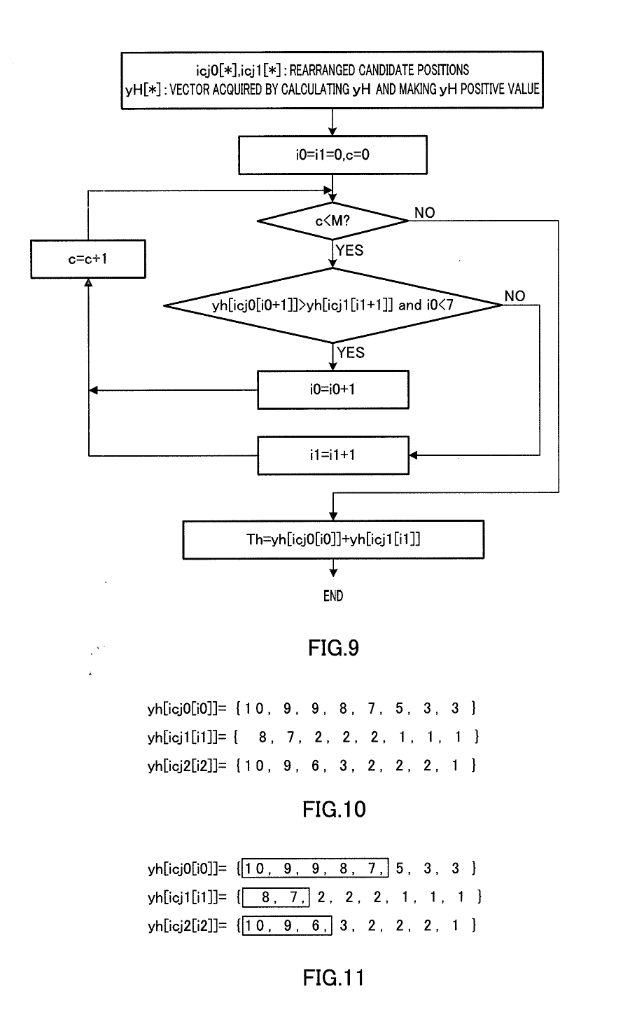

Also, FIG. 9 is a flowchart showing the algorithm to calculate a threshold according to the present embodiment, and decides whether or not to perform a search for the fourth pulse based on the search results up to the second pulses. Here, in the flowchart of FIG. 9, i0 and i1 represent the index in each channel to calculate a threshold, c represents the counter, Th represents the threshold, and M represents the number of candidates to determine the magnitude of a threshold. M is a constant and is set to around 8 to 12.

The method of calculating a threshold according to the present embodiment will be explained below using a detailed example. For example, assume that sorted correlation values are provided as shown in FIG. 10 and the number of candidates M is “10.” In this case, by executing the algorithm shown in FIG. 8, a search for candidate positions is performed up to the boxed parts in FIG. 11.

Therefore, in this example, the reference candidate positions in channels are i0=5, i1=2 and i2=3, and threshold Th is 7+7+6=20.

Further, with the present embodiment, candidate positions may be subject to search over channels in descending order of the correlation values, to specify the reference candidate positions when a product of the numbers of candidate positions subjected to search reaches a predetermined product.

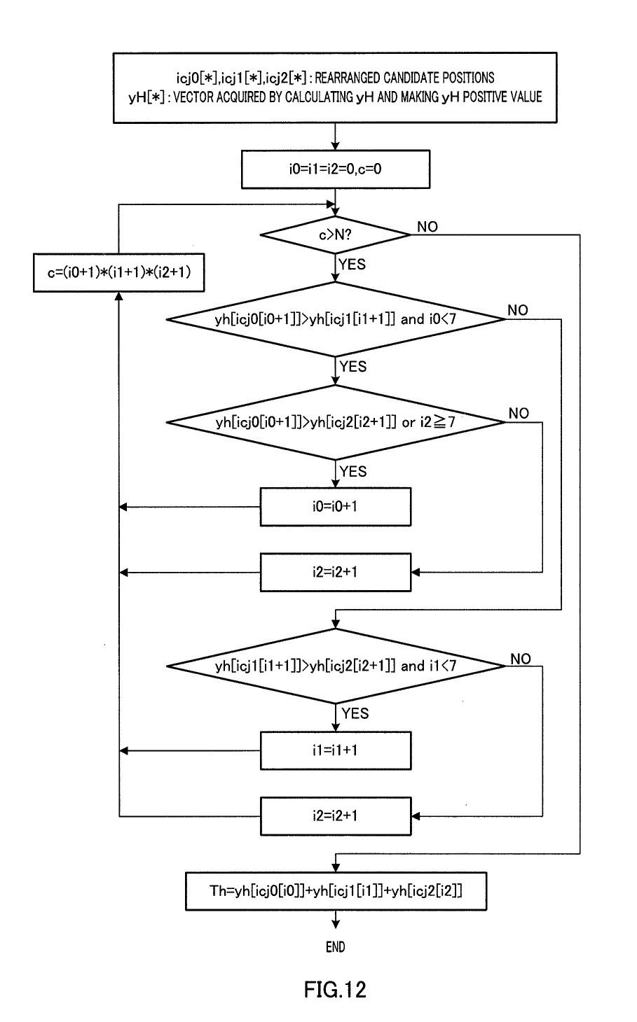

FIG. 12 is a flowchart showing the algorithm to calculate a threshold according to the above-described method. Here, in the flowchart of FIG. 12, i0, i1 and i2 represent the index in each channel to calculate a threshold, c represents the counter, Th represents the threshold, and M represents the number of candidates to determine the magnitude of a threshold. N is a constant and is set to around 30 to 60.

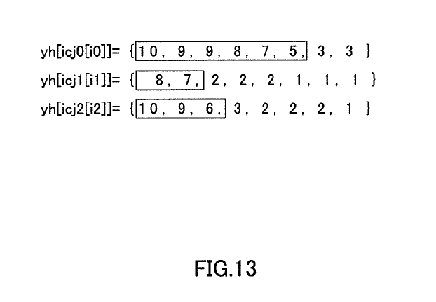

In this case, for example, assume that sorted correlation values are provided as shown in above FIG. 10 and multiplication N is “35.” Here, by executing the algorithm shown in FIG. 12, “6×2×3=36>35” is provided, and therefore a search for candidate positions is performed up to the boxed parts in FIG. 13.

Therefore, in this example, the reference candidate positions in channels are i0=6, i1=2 and i2=3, and threshold Th is 5+7+6=18.

Thus, the present embodiment sets a threshold to decide a search stop based on the correlation value between synthesis sound of pulses allocated in candidate positions in each channel and the quantization target, and, if a sum of the correlation values is lower than a threshold in the middle of the loop search, does not perform a loop search in a loop of a greater depth. Further, according to the present embodiment, the magnitudes of the correlation values of sorted candidate positions in each channel are evaluated over a plurality of channels to specify the reference candidate position in each channel, and the correlation values of the specified reference candidate positions are added to calculate a threshold.

By this means, it is possible to save the amount of calculations for search processing when the correlation value is low, and reduce an average amount of calculations without degrading coding performance.

Also, the present invention is not limited to the above-described embodiment and can be implemented with various changes. For example, although a case has been described above with the present embodiment where whether or not to terminate a search is decided in a depth of the third loop, the present invention may decide whether or not to terminate a search in a depth of a different loop.

Further, although sorting and search of pulse candidate positions according to the above embodiment are performed in a speech coding apparatus, these sorting and search may form software. For example, it may be possible to store the sorting and search program in a ROM and perform operations according to this program under CPU command. Also, it may be possible to store the sorting and search program in a computer-readable storage medium, record the sorting and search program of this storage medium in a RAM and perform operations according to this program. Even in this case, it is possible to provide the same operations and effects as in the above embodiment.

Further, although an example case has been described with the present embodiment where an algebraic codebook is used as a fixed excitation codebook, the present invention is not limited to this, and is also applicable to a multi-path codebook and a fixed codebook with fixed waveforms written in a ROM. In this case, the individual indexes of channels are associated with individual fixed waveform vectors.

Further, although a case has been described with the present embodiment where the present invention is applied to CELP, the present invention is not limited to this, and is also applicable to other coding with an excitation codebook. This is because the present invention depends on processing in a fixed excitation codebook vector and does not depend on the existence/inexistence of an adaptive excitation codebook and a method of analyzing a spectrum envelope.

Further, although an example case has been described with the present embodiment where a fixed excitation codebook is used, the present invention is not limited to this, and is applicable to multi-stage vector quantization of spectrum coding and multi-stage vector quantization of vectors in image coding. This is because the present invention contributes to reduction of the number of candidates in a multi-loop search and is not limited by the coding target.

Further, not only a speech signal but also an audio signal can be used as the signal according to the present invention. It is also possible to employ a configuration in which the present invention is applied to an LPC prediction residual signal instead of an input signal.

The coding apparatus according to the present invention can be mounted on a communication terminal apparatus and base station apparatus in a mobile communication system, so that it is possible to provide a communication terminal apparatus, base station apparatus and mobile communication system having the same operational effect as above.

Although a case has been described with the above embodiment as an example where the present invention is implemented with hardware, the present invention can be implemented with software. For example, by describing the algorithm according to the present invention in a programming language, storing this program in a memory and making the information processing section execute this program, it is possible to implement the same function as the coding apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-053501, filed on Mar. 2, 2007, including the specification, drawings and abstract, is incorporated herein by reference in its entirety.

### INDUSTRIAL APPLICABILITY

The present invention is suitable to a coding apparatus that encodes speech signals and audio signals.

1. A coding apparatus, using a codebook which represents a fixed excitation by a small number of pulses and which sets candidate positions of a pulse on a per channel basis, the apparatus searching for an optimal pulse position from the candidate positions of each channel in a loop of a depth corresponding to a number of channels, and comprising:
a candidate position sorting section that rearranges the candidate positions of each channel subject to search in a search loop, based on correlation values between synthesis sounds of pulses allocated in the candidate positions of each channel, and a quantization target;
a threshold calculating section that evaluates magnitudes of the correlation values of the rearranged candidate positions of each channel, over a plurality of channels, specifies a reference candidate position of each channel based on evaluation results, and calculates a threshold using a correlation value of the reference candidate position of each channel; and
a search controlling section that searches for a pulse position in order of the rearranged candidate positions and terminates a search based on a comparison result between a representative value set using correlation values of candidate positions subjected to search in a channel of a search target, and the threshold.

2. The coding apparatus according to claim 1, wherein the candidate position sorting section rearranges the candidate positions of each channel subject to search in the search loop in descending order of the correlation values.

3. The coding apparatus according to claim 2, wherein, in the threshold calculating section, the candidate positions are subjected to search over the channels in descending order of the correlation values, and the reference candidate positions are specified when a sum of numbers of candidate positions subjected to search reaches a predetermined number of candidates.

4. The coding apparatus according to claim 2, wherein, in the threshold calculating section, the candidate positions are subjected to search over the channels in descending order of the correlation values, and the reference candidate positions are specified when a product of numbers of candidate positions subjected to search reaches a predetermined product.

5. The coding apparatus according to claim 1, wherein:
the threshold calculating section calculates the threshold by adding the correlation values of the reference candidate positions of the channels; and
the search controlling section calculates, as the representative value, a sum of the correlation values subjected to search in the channel of the search target, and terminates a search when the representative value is lower than the threshold.

6. A coding method of, using a codebook which represents a fixed excitation by a small number of pulses and which sets candidate positions of a pulse on a per channel basis, the method searching for an optimal pulse position from the candidate positions of each channel in a loop of a depth corresponding to a number of channels, and comprising:
a candidate position sorting step of rearranging the candidate positions of each channel subject to search in a search loop, based on correlation values between synthesis sounds of pulses allocated in the candidate positions of each channel, and a quantization target;
a threshold calculating step of evaluating magnitudes of the correlation values of the rearranged candidate positions of each channel, over a plurality of channels, specifies a reference candidate position of each channel based on evaluation results, and calculates a threshold using a correlation value of the reference candidate position of each channel; and
a search controlling step of searching for a pulse position in order of the rearranged candidate positions and terminates a search based on a comparison result between a representative value set using correlation values of candidate positions subjected to search in a channel of a search target, and the threshold.
